(19) United States
(12) Patent Application Publication
(10) Pub. No.: US 2024/0271065 A1
(43) Pub. Date: Aug. 15, 2024

(54) ANTI-MICROBIAL PARTICLES

(71) Applicant: The Procter & Gamble Company, Cincinnati, OH (US)

(72) Inventors: Rui SHEN, Beijing (CN); Pu ZHAO, Beijing (CN)

(21) Appl. No.: 18/617,930

(22) Filed: Mar. 27, 2024

Related U.S. Application Data
(63) Continuation of application No. PCT/CN2021/121601, filed on Sep. 29, 2021.

(51) Int. Cl. C11D 3/48; C11D 1/86; C11D 3/40; C11D 3/50

(52) U.S. Cl. CPC C11D 3/48; C11D 1/86; C11D 3/40; C11D 3/505; C11D 2111/12

(57) ABSTRACT

A composition comprising a plurality of anti-microbial particles that each comprises: a) from about 20% to about 99.9% of polyalkylene glycol having a weight average molecular weight from about 2000 to about 40000 Daltons by total weight of said particle; and b) from about 0.1% to about 50% of an anti-microbial agent by total weight of said particle, wherein each of said plurality of particles has a mass from about 5 mg to about 500 mg. Preferably, the anti-microbial agent can be selected from chloroxylenol, percarbonate, silver, methyl-diisopropanolamine-based (MDIPA-based) quaternary ammonium compound, didecyldimethyl ammonium chlorides (DDAC), alkyl dimethyl benzalkonium chlorides (ADBAC) and alkyl dimethyl benzalkonium chloride (ADEBAC), and any combinations thereof.

### FIELD OF THE INVENTION

Through-the-wash laundry additive and fabric treatment compositions comprising same.

### BACKGROUND OF THE INVENTION

Consumer products have evolved to address user needs for an anti-microbial benefit, in addition to their original intended functions. For example, an anti-microbial laundry detergent product is desired by users as it cleans fabrics whilst having an anti-microbial benefit on fabrics. Currently, various anti-microbial agents, e.g., bleaching agents, 4-chloro-3,5-dimethyl phenol (also called Chloroxylenol or PCMX), Benzalkonium Chloride (BKC), diphenyl ethers, are known for use in consumer product formulations to deliver an anti-microbial effect.

However, in the context of laundry detergent, it is challenging to achieve a desired efficacy of the anti-microbial agents on fabrics. Specifically, during a washing cycle, most of the active ingredients, including the incorporated anti-microbial agents, are eventually washed away along with the washing solution. Consequently, only a small amount of anti-microbial agents released by the laundry detergent can be deposited onto washed fabrics. In order to compensate for such low deposition rate of the anti-microbial agents, manufacturers will have to increase the concentration of the anti-microbial agents in the laundry detergent products, which not only leads to increased cost but also environmental concerns due to an increased amount of anti-microbial agents being washed away during the laundering process and released into the environment.

Particulate laundry additives incorporating anti-microbial agents thus become desirable for consumer. Consumers like laundry additives that are packaged in a manner that enables the consumer to use a custom amount of the laundry additive based on the consumer's judgment of how much of the laundry additive is needed to provide the desired benefit, e.g., anti-microbial benefit. Such laundry anti-microbial additives are conveniently provided through the wash along with a fully formulated fabric care composition. However, there is challenges associated with manufacturing process of the particulate laundry additives, e.g. stability at higher temperature or humidity, etc.

Therefore, there is a continuous need to provide particulate anti-microbial laundry additives that can be easily and cost-effectively manufactured, have good dissolution in water and provide satisfactory anti-microbial benefits (even under high temperature or humidity conditions).

### SUMMARY OF THE INVENTION

The present invention provides a composition comprising a plurality of anti-microbial particles that each comprises: (a) from 20% to 99% of water-soluble carrier by total weight of said particle; and (b) from 0.001% to 30% of an anti-microbial agent selected from the group consisting of chloroxylenol (i.e. PCMX), percarbonate, silver, methyl-diisopropanolamine-based (MDIPA-based) quaternary ammonium compound, didecyldimethyl ammonium chlorides (DDAC), alkyl dimethyl benzalkonium chlorides (ADBAC) and alkyl dimethyl benzalkonium chloride (ADEBAC), and any combinations thereof, by total weight of said particle; wherein each of said plurality of anti-microbial particles has a mass between about 5 mg to about 500 mg. Preferably the water-soluble carrier is polyalkylene glycol, especially polyalkylene glycol having a weight average molecular weight from 2000 to 40000 Daltons.

The anti-microbial particles comprised in the composition of the present invention can comprise:
i) from 0.1% to 30%, preferably from 0.3% to 20%, more preferably from 0.4% to 15%, most preferably from 0.5% to 10% of chloroxylenol by total weight of said particle; and/or
ii) from 0.1% to 30%, preferably from 0.3% to 20%, more preferably from 0.4% to 15%, most preferably from 0.5% to 10% of percarbonate by total weight of said particle, said percarbonate is preferably sodium percarbonate; and/or
iii) from 0.1% to 30%, preferably from 0.15% to 10%, more preferably from 0.2% to 5%, most preferably from 0.25% to 1% of silver by total weight of said particle, wherein said silver is preferably silver ions or nano silver; and/or
iv) from 0.1% to 30%, preferably from 0.3% to 20%, more preferably from 0.4% to 15%, most preferably from 0.5% to 10% of methyl-diisopropanolamine-based (MDIPA-based) quaternary ammonium compound by total weight of said particle, wherein said MDIPA-based quaternary ammonium compound is preferably di-isopropyl ester dimethyl ammonium methyl sulfate; and/or
v) from 0.1% to 30%, preferably from 0.3% to 20%, more preferably from 0.4% to 15%, most preferably from 0.5% to 10% of didecyldimethyl ammonium chlorides (DDAC) by total weight of said particle; and/or
vi) from 0.1% to 30%, preferably from 0.3% to 20%, more preferably from 0.4% to 15%, most preferably from 0.5% to 10% of benzakonium chlorides by total weight of said particle, wherein said benzakonium chlorides are preferably alkyl dimethyl benzalkonium chlorides (ADBAC) and/or alkyl dimethyl benzalkonium chloride (ADEBAC); and/or
vii) from 0.1% to 30%, preferably from 0.3% to 20%, more preferably from 0.4% to 15%, most preferably from 0.5% to 10% of cationic polymers by total weight of said particle, wherein said cationic polymer is preferably a cationic polysaccharide, wherein said cationic polymer is more preferably polymeric quaternary ammonium salt of hydroxyethylcellulose which has been reacted with an epoxide substituted with a trimethylammonium group (WK30).

Preferably, The laundry additive composition according to any one of the preceding claims, wherein each of said plurality of anti-microbial particles comprised in the laundry additive composition further comprises from 0.1% to 30%, preferably from 0.5% to 20%, more preferably from 1% to 15%, of a perfume by total weight of said particle. The perfume can be selected from the group consisting of free perfumes, pro-perfumes, encapsulated perfumes, perfume microcapsules, and combinations thereof. Preferably said perfume comprises a combination of free perfumes and perfume microcapsules; wherein the weight ratio of free perfumes to perfume microcapsules in said each anti-microbial particle can be from 1:5 to 20:1, preferably from 1:2 to 10:1, more preferably from 1:1 to 5:1, most preferably from 1.5:1 to 3:1.

When the same amount of anti-microbial agent is provided, it may exhibit higher anti-microbial efficacy when formulated into the anti-microbial particles of the present invention, in comparison with being added into a powder or liquid laundry detergent product separately under the same condition of making process. Without being bound by any theory, it is believed that such anti-microbial particles provide controlled/sustained release of the anti-microbial agent into the wash liquor during the laundering process.

Further, when provided as a stand-alone fabric treatment product, such anti-microbial particles of the present invention offer greater dosing flexibility to enable more effective delivery of the anti-microbial agent. The consumers can choose to dose more or less of the anti-microbial agent as needed, separately from the surfactants or other detersive actives in the laundry detergent products. The consumer can also choose to add the anti-microbial particles of the present invention at a specific stage of the laundering process, e.g., after wash or during the rinse cycle, to increase deposition rate of such anti-microbial agent onto fabrics.

Still further, such anti-microbial particles of the present invention can be readily incorporated into particulate laundry detergent compositions that also contain detergent particles. Particulate laundry detergent compositions typically have a significantly higher Equilibrium pH than liquid laundry detergent compositions, and such high-pH environment is not beneficiary to deposition of certain anti-microbial agents as mentioned hereinabove. In order to solve this problem, it is possible to reformulate the particulate laundry detergent composition to reduce the Equilibrium pH of, but the cost and complexity associated with such reformulation are significant. Therefore, the anti-microbial particles of the present invention provide an alternative solution that is both simple and more cost-effective. Without being bound by any theory, it is believed that the water-soluble carrier in such anti-microbial particles functions to isolate the anti-microbial agent from the high-PH environment of the typical particulate laundry detergent products, thereby improving the deposition rate of such anti-microbial agent.

Still further, when such anti-microbial particles contain perfume ingredients therein, improved freshness benefit and better malodor control benefit are surprisingly observed. Without being bound by any theory, it is believed that the anti-microbial agent in such particles interacts with the perfume ingredients to improve the release profile and deposition of such perfume ingredients (especially perfume microcapsules) onto the fabrics.

These and other aspects of the present invention will become more apparent upon reading the following detailed description of the invention.

### DETAILED DESCRIPTION OF THE INVENTION

Features and benefits of the various embodiments of the present invention will become apparent from the following description, which includes examples of specific embodiments intended to give a broad representation of the invention. Various modifications will be apparent to those skilled in the art from this description and from practice of the invention. The scope of the present invention is not intended to be limited to the particular forms disclosed and the invention covers all modifications, equivalents, and alternatives falling within the spirit and scope of the invention as defined by the claims.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

As used herein, terms such as “a” and “an” when used in a claim, are understood to mean one or more of what is claimed or described. The terms “comprise,” “comprises,” “comprising,” “contain,” “contains,” “containing,” “include,” “includes” and “including” are all meant to be non-limiting.

The term “aspect ratio” refers to the ratio of the longest dimension of the particles over its shortest dimension. For example, when such particles have a hemispherical or compressed hemispherical shape, the aspect ratio is the ratio between the based diameter of the particles over its height.

The term “particulate laundry detergent composition” refers to a solid powdery or granular laundry detergent composition, preferably a free-flowing powdery or granular laundry detergent composition, such as an all-purpose or heavy-duty washing agent for fabrics, as well as laundry auxiliaries such as bleach actives, rinse aids, additives, or pre-treat products.

The term “laundry additive composition” refers to a laundry composition providing addition benefits supplementary to detersive purpose. Preferably such laundry additive composition does not contain detersive actives such as surfactants.

The term “detergent particle” refers to a particle comprising one or more detersive actives, such as surfactants, builders, bleach actives, enzymes, polymers, chelants, softeners, suds suppressors, suds boosters, brighteners, dye transfer inhibitors, and the like. Preferably, such detergent particles contain one or more surfactants, especially an anionic surfactant and/or a nonionic surfactant.

The term “anti-microbial particle” refers to a particle comprising one or more anti-microbial agents in a water-soluble carrier.

The term “consisting essentially of” means that the composition contains less than about 10%, preferably less than about 5%, of ingredients other than those listed.

Further, the term “substantially free of” or “substantially free from” means that the indicated material is present in the amount of from 0 wt % to about 1 wt %, preferably from 0 wt % to about 0.5 wt %, more preferably from 0 wt % to about 0.2 wt %. The term “essentially free of” means that the indicated material is present in the amount of from 0 wt % to about 0.1 wt %, preferably from 0 wt % to about 0.01 wt %, more preferably it is not present at analytically detectable levels.

As used herein, all concentrations and ratios are on a weight basis unless otherwise specified. All temperatures herein are in degrees Celsius (C) unless otherwise indicated. All conditions herein are at 20° C. and under the atmospheric pressure, unless otherwise specifically stated. All polymer molecular weights are determined by weight average number molecular weight unless otherwise specifically noted.

### Anti-Microbial Particles

The composition of the present invention comprises a plurality of anti-microbial particles that each comprises: (a) from about 20% to about 99.9% of a water-soluble carrier by total weight of said particle; and (b) from 0.001% to 30% of an anti-microbial agent; wherein each of said plurality of anti-microbial particles has a mass from about 5 mg to about 500 mg.

Preferably, the anti-microbial agent can be selected from the group consisting of chloroxylenol (i.e. PCMX), percarbonate, silver, methyl-diisopropanolamine-based (MDIPA-based) quaternary ammonium compound, didecyldimethyl ammonium chlorides (DDAC), benzakonium chlorides such as alkyl dimethyl benzalkonium chlorides (ADBAC) and alkyl dimethyl benzalkonium chloride (ADEBAC), cationic polymers, and any combinations thereof.

### Chloroxylenol (PCMX)

chloroxylenol, also known as 4-chloro-3,5-dimethyl phenol or para-chloro-meta-xylenol (PCMX), is an antiseptic and disinfectant which is used for skin disinfection and cleaning surgical instruments. It has been also used in laundry applications. It has the following formula (II):

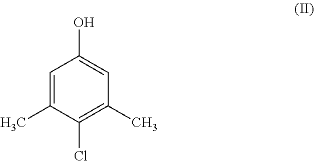

In some examples, the anti-microbial particles comprised in the composition of the present invention can comprise from about 0.1% to about 30%, preferably from about 0.5% to about 25%, of chloroxylenol (i.e. PCMX), by total weight of said particle. Without being bound by any theory, if PCMX level is too high, it is hard to form particles in room temperature. While if the PCMX level is too low, the anti-microbial benefit will not be achieved. For example, the PCMX can be present in the anti-microbial particles in an amount of from about 1% to about 20%, or from about 2% to about 18%.

### Percarbonate and TAED

In other examples, the anti-microbial particles comprised in the composition of the present invention can comprise hydrogen peroxide generator and peracid catalyst. The hydrogen peroxide generator can be selected from the group consisting of an alkali metal perborate, alkali metal percarbonate, alkali metal perphosphate, alkali metal persilicate, alkali metal persulfate, and a combination thereof. The peracid catalyst is an agent that contains an acetyl donor group or an acyl donor group or a combination thereof, wherein the agent contains an —O—C(O)CH₃ donor group, an —N—C(O)CH₃ donor group, an —O—C(O)R¹) donor group or an —N—C(O)R² donor group, wherein R¹ and R² each individually is C1 to C20 alkyl; or the peracid catalyst is selected from the group consisting of monoacetin, diacetin, triacetin, glucose pentaacetate, lactose octaacetate, mannitol hexaacetate, sucrose octaacetate, N,N,N′N′-tetraacetylethylene-diamine (TAED), N,N,N′N′-tetraacetylmethylene-diamine (TAMD), N-acetyl glycine, N-acetyl-methionine, 6-acetamidohexanoic acid, N-acetyl-L-cysteine, 4-acetamido-phenol, N-acetyl-L-glutamine, and N,N′,N″,N″-tetraacetyl glycoluril (TAGU).

In some preferably examples, the anti-microbial particles comprised in the composition of the present invention comprise from about 0.1% to about 30%, preferably from about 0.3% to about 20%, more preferably from about 0.4% to about 15%, most preferably from about 0.5% to about 10% of percarbonate by total weight of said each anti-microbial particle. Said percarbonate is preferably sodium percarbonate.

The anti-microbial particles can further comprise N,N,N′N′-tetraacetylethylene-diamine (TAED). The amount of TAED present in the anti-microbial particles can be from about 0.01% to about 15% by weight, preferably from about 0.2% to about 10% by weight. TAED is known in the dry chemical industry to be useful for making powder and compressed tablet compositions because TAED is stable in dry form and compatible with the peroxygen chemistries.

Preferably, the total amount of percarbonate and TAED in the anti-microbial particle can be from about 1% to about 30%, preferably form about 2% to about 25%, more preferably from about 3% to about 20%, by total weight of said each anti-microbial particle. The weight ratio of percarbonate to TAED can be from about 10:1 to about 1.1:1, for example, the weight ratio of percarbonate to TAED can be about 9:1, or 8:1, or 7:1, or 5:1, or 3:1, or 2:1, or 1.8:1, or 1.6:1, or 1.5:1, or 1.4:1, or 1.3:1 or 1.2:1, or any ranges therebetween.

Percarbonate and TAED are usually compressed by tableting process in pharmaceutical and food industries to create compressed solids. The anti-microbial particles of the present invention, however, are made by rotoforming process in which high temperature melting materials are conveniently processed on a rotoformer and yield particles that are hemispherical or semi-hemispherical, and the like. The applicant surprisingly discovered that percarbonate and TAED can survive the high temperature melting process and form homogenous anti-microbial particles through rotoforming process, without degrading the bleaching activity.

Alternatively, the present invention provides a composition comprising:
(i) a plurality of first particles comprising:
   25% to 97% by weight of a water-soluble first carrier,
   0.2% to 30% by weight of percarbonate,
   optionally a perfume,
   wherein each of said plurality of first particles has a mass of from 5 mg to 200 mg; and
(ii) a plurality of second particles comprising:
   25% to 97% by weight of a water-soluble second carrier,
   0.05% to 15% by weight of TAED,
   optionally a perfume,
   wherein each of said plurality of second particles has a mass of from 5 mg to 200 mg.

Preferably, said first carrier and said second carrier are selected from the group consisting of polyethylene glycol, sodium acetate, sodium bicarbonate, sodium chloride, sodium silicate, polypropylene glycol polyoxoalkylene, polyethylene glycol fatty acid ester, polyethylene glycol ether, sodium sulfate, starch, and mixtures thereof.

Preferably, said composition comprises from 10% to 90% by weight of said first particles and from 10% to 90% by weight of said second particles. Preferably, said first particles and said second particles in the composition of the present invention are together in a single chamber of a package.

Incorporating percarbonate and TAED into water-soluble carriers to form particles separately may provide stable particles even packed in a single chamber of a package. When dosed into a laundry process, both particles dissolve into water and release the actives, where at that time percarbonate and TAED may react and bring about anti-microbiol benefit.

### Silver

In some other examples, the anti-microbial particles comprised in the composition of the present invention comprise from about 0.001% to about 5%, preferably from about 0.005% to about 2%, more preferably from about 0.01% to about 1%, most preferably from about 0.02% to about 0.5% of silver by total weight of said particle, wherein said silver is preferably silver ions or nano silver. Without being bound by any theory, too much of silver using in laundry process may lead to darkening due to residue on fabrics. Therefore, the concentration of silver present in the particles of the present invention helps to provide anti-microbial benefit, at the same time avoiding darkening.

### Other Anti-Microbial Agents

In some other examples, the anti-microbial particles comprised in the composition of the present invention comprise from about 0.1% to about 30%, preferably from about 0.3% to about 20%, more preferably from about 0.4% to 15%, most preferably from about 0.5% to 10% of methyl-diisopropanolamine-based (MDIPA-based) quaternary ammonium compound by total weight of said each anti-microbial particle, wherein said MDIPA-based quaternary ammonium compound is preferably di-isopropyl ester dimethyl ammonium methyl sulfate.

In some other examples, the anti-microbial particles comprised in the composition of the present invention comprise from about 0.1% to about 30%, preferably from about 0.3% to about 20%, more preferably from about 0.4% to 15%, most preferably from about 0.5% to 10% of didecyldimethyl ammonium chlorides (DDAC) by total weight of said each anti-microbial particle.

In some other examples, the anti-microbial particles comprised in the composition of the present invention comprise from about 0.1% to about 30%, preferably from about 0.3% to about 20%, more preferably from about 0.4% to 15%, most preferably from about 0.5% to 10% of benzakonium chlorides by total weight of said each anti-microbial particle, wherein said benzakonium chlorides are preferably alkyl dimethyl benzalkonium chlorides (ADBAC) and/or alkyl dimethyl benzalkonium chloride (ADEBAC).

In some other examples, the anti-microbial particles comprised in the composition of the present invention comprise from about 0.1% to about 30%, preferably from about 0.3% to about 20%, more preferably from about 0.4% to 15%, most preferably from about 0.5% to 10% of cationic polymers by total weight of said each anti-microbial particle, wherein said cationic polymer is preferably a cationic polysaccharide, wherein said cationic polymer is more preferably polymeric quaternary ammonium salt of hydroxyethylcellulose which has been reacted with an epoxide substituted with a trimethylammonium group (WK30).

In addition to the anti-microbial agents disclosed hereinabove, other anti-microbial agents may also be present, provided that these are not present at a level which causes instability in the formulation. Among such useful further antimicrobial agents are chelating agents, which are particularly useful in reducing the resistance of Gram negative microbes in hard water. Acid biocides may also be present.

In addition to the above-mentioned anti-microbial agent, each of the plurality of anti-microbial particles of the present invention also comprises from about 25% to about 99%, preferably from about 30% to about 95%, more preferably from about 40% to about 94%, most preferably from about 50% to about 93%, of said water-soluble carrier by total weight of said each anti-microbial particle.

### Water-Soluble Carrier

The water-soluble carrier can be a material that is soluble in a wash liquor within a short period of time, for instance less than about 10 minutes. The water-soluble carrier can be selected from the group consisting of water-soluble inorganic alkali metal salt, water-soluble alkaline earth metal salt, water-soluble organic alkali metal salt, water-soluble organic alkaline earth metal salt, water-soluble carbohydrate, water-soluble silicate, water-soluble urea, water-soluble polymers, and any combination thereof.

Alkali metal salts can be, for example, selected from the group consisting of salts of lithium, salts of sodium, and salts of potassium, and any combination thereof. Useful alkali metal salts can be, for example, selected from the group consisting of alkali metal fluorides, alkali metal chlorides, alkali metal bromides, alkali metal iodides, alkali metal sulfates, alkali metal bisulfates, alkali metal phosphates, alkali metal monohydrogen phosphates, alkali metal dihydrogen phosphates, alkali metal carbonates, alkali metal monohydrogen carbonates, alkali metal acetates, alkali metal citrates, alkali metal lactates, alkali metal pyruvates, alkali metal silicates, alkali metal ascorbates, and combinations thereof.

Alkali metal salts can be selected from the group consisting of sodium fluoride, sodium chloride, sodium bromide, sodium iodide, sodium sulfate, sodium bisulfate, sodium phosphate, sodium monohydrogen phosphate, sodium dihydrogen phosphate, sodium carbonate, sodium hydrogen carbonate, sodium acetate, sodium citrate, sodium lactate, sodium tartrate, sodium silicate, sodium ascorbate, potassium fluoride, potassium chloride, potassium bromide, potassium iodide, potassium sulfate, potassium bisulfate, potassium phosphate, potassium monohydrogen phosphate, potassium dihydrogen phosphate, potassium carbonate, potassium monohydrogen carbonate, potassium acetate, potassium citrate, potassium lactate, potassium tartrate, potassium silicate, potassium, ascorbate, and combinations thereof.

Alkaline earth metal salts can be selected from the group consisting of salts of magnesium, salts of calcium, and the like, and combinations thereof. Alkaline earth metal salts can be selected from the group consisting of alkaline metal fluorides, alkaline metal chlorides, alkaline metal bromides, alkaline metal iodides, alkaline metal sulfates, alkaline metal bisulfates, alkaline metal phosphates, alkaline metal monohydrogen phosphates, alkaline metal dihydrogen phosphates, alkaline metal carbonates, alkaline metal monohydrogen carbonates, alkaline metal acetates, alkaline metal citrates, alkaline metal lactates, alkaline metal pyruvates, alkaline metal silicates, alkaline metal ascorbates, and combinations thereof. Alkaline earth metal salts can be selected from the group consisting of magnesium fluoride, magnesium chloride, magnesium bromide, magnesium iodide, magnesium sulfate, magnesium phosphate, magnesium monohydrogen phosphate, magnesium dihydrogen phosphate, magnesium carbonate, magnesium monohydrogen carbonate, magnesium acetate, magnesium citrate, magnesium lactate, magnesium tartrate, magnesium silicate, magnesium ascorbate, calcium fluoride, calcium chloride, calcium bromide, calcium iodide, calcium sulfate, calcium phosphate, calcium monohydrogen phosphate, calcium dihydrogen phosphate, calcium carbonate, calcium monohydrogen carbonate, calcium acetate, calcium citrate, calcium lactate, calcium tartrate, calcium silicate, calcium ascorbate, and combinations thereof.

Inorganic salts, such as inorganic alkali metal salts and inorganic alkaline earth metal salts, do not contain carbon. Organic salts, such as organic alkali metal salts and organic alkaline earth metal salts, contain carbon. The organic salt can be an alkali metal salt or an alkaline earth metal salt of sorbic acid (i.e., asorbate). Sorbates can be selected from the group consisting of sodium sorbate, potassium sorbate, magnesium sorbate, calcium sorbate, and combinations thereof.

The water-soluble carrier can be or comprise a material selected from the group consisting of a water-soluble inorganic alkali metal salt, a water-soluble organic alkali metal salt, a water-soluble inorganic alkaline earth metal salt, a water-soluble organic alkaline earth metal salt, a water-soluble carbohydrate, a water-soluble silicate, a water-soluble urea, and combinations thereof. The water-soluble carrier can be selected from the group consisting of sodium chloride, potassium chloride, calcium chloride, magnesium chloride, sodium sulfate, potassium sulfate, magnesium sulfate, sodium carbonate, potassium carbonate, sodium hydrogen carbonate, potassium hydrogen carbonate, sodium acetate, potassium acetate, sodium citrate, potassium citrate, sodium tartrate, potassium tartrate, potassium sodium tartrate, calcium lactate, water glass, sodium silicate, potassium silicate, dextrose, fructose, galactose, isoglucose, glucose, sucrose, raffinose, isomalt, xylitol, candy sugar, coarse sugar, and combinations thereof. In one embodiment, the water-soluble carrier can be sodium chloride. In one embodiment, the water-soluble carrier can be table salt.

The water-soluble carrier can be or comprise a material selected from the group consisting of sodium bicarbonate, sodium sulfate, sodium carbonate, sodium formate, calcium formate, sodium chloride, sucrose, maltodextrin, corn syrup solids, corn starch, wheat starch, rice starch, potato starch, tapioca starch, clay, silicate, citric acid carboxymethyl cellulose, fatty acid, fatty alcohol, glyceryl diester of hydrogenated tallow, glycerol, and combinations thereof.

The water-soluble carrier can be selected from the group consisting of water-soluble organic alkali metal salt, water-soluble inorganic alkaline earth metal salt, water-soluble organic alkaline earth metal salt, water-soluble carbohydrate, water-soluble silicate, water-soluble urea, starch, clay, water insoluble silicate, citric acid carboxymethyl cellulose, fatty acid, fatty alcohol, glyceryl diester of hydrogenated tallow, glycerol, polyethylene glycol, and combinations thereof.

The water-soluble carrier can be selected from the group consisting of disaccharides, polysaccharides, silicates, zeolites, carbonates, sulfates, citrates, and combinations thereof.

The water-soluble carrier can be a water-soluble polymer. Water-soluble polymers can be selected from the group consisting of polyvinyl alcohols (PVA), modified PVAs; polyvinyl pyrrolidone; PVA copolymers such as PVA/polyvinyl pyrrolidone and PVA/polyvinyl amine; partially hydrolyzed polyvinyl acetate; polyalkylene oxides such as polyethylene oxide; polyethylene glycols; acrylamide; acrylic acid; cellulose, alkyl cellulosics such as methyl cellulose, ethyl cellulose and propyl cellulose; cellulose ethers; cellulose esters; cellulose amides; polyvinyl acetates; polycarboxylic acids and salts; polyaminoacids or peptides; polyamides; polyacrylamide; copolymers of maleic/acrylic acids; polysaccharides including starch, modified starch; gelatin; alginates; xyloglucans, other hemicellulosic polysaccharides including xylan, glucuronoxylan, arabinoxylan, mannan, glucomannan and galactoglucomannan; and natural gums such as pectin, xanthan, and carrageenan, locus bean, arabic, tragacanth; and combinations thereof. In one embodiment the polymer comprises polyacrylates, especially sulfonated polyacrylates and water-soluble acrylate copolymers; and alkylhydroxy cellulosics such as methylcellulose, carboxymethylcellulose sodium, modified carboxy-methylcellulose, dextrin, ethylcellulose, propylcellulose, hydroxyethyl cellulose, hydroxypropyl methylcellulose, maltodextrin, polymethacrylates. In yet another embodiment the water-soluble polymer can be selected from the group consisting of PVA; PVA copolymers; hydroxypropyl methyl cellulose (HPMC); and mixtures thereof.

The water-soluble carrier can be selected from the group consisting of polyvinyl alcohol, modified polyvinyl alcohol, polyvinyl pyrrolidone, polyvinyl alcohol/polyvinyl pyrrolidone, polyvinyl alcohol/polyvinyl amine, partially hydrolyzed polyvinyl acetate, polyalkylene oxide, polyethylene glycol, acrylamide, acrylic acid, cellulose, alkyl cellulosics, methyl cellulose, ethyl cellulose, propyl cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides, starch, modified starch, gelatin, alginates, xyloglucans, hemicellulosic polysaccharides, xylan, glucuronoxylan, arabinoxylan, mannan, glucomannan, galactoglucomannan, natural gums, pectin, xanthan, carrageenan, locus bean, arabic, tragacanth, polyacrylates, sulfonated polyacrylates, water-soluble acrylate copolymers, alkylhydroxy cellulosics, methylcellulose, carboxymethylcellulose sodium, modified carboxy-methylcellulose, dextrin, ethylcellulose, propylcellulose, hydroxyethyl cellulose, hydroxypropyl methylcellulose, maltodextrin, polymethacrylates, polyvinyl alcohol copolymers, hydroxypropyl methyl cellulose, and mixtures thereof.

The water-soluble carrier can comprise a material selected from the group consisting of: a polyalkylene polymer of formula H—(C₂H₄O)ₓ—(CH(CH₃)CH₂O)_{y}—(C₂H₄O)_{z}—OH wherein x is from about 50 to about 300, y is from about 20 to about 100, and z is from about 10 to about 200; a polyethylene glycol fatty acid ester of formula (C₂H₄O)_{q}—C(O)O—(CH₂)ᵣ—CH₃ wherein q is from about 20 to about 200 and r is from about 10 to about 30; a polyethylene glycol fatty alcohol ether of formula HO—(C₂H₄O)₅—(CH₂)ₜ)—CH₃ wherein s is from about 30 to about 250 and t is from about 10 to about 30; and mixtures thereof. The polyalkylene polymer of formula H—(C₂H₄O)ₓ—(CH(CH₃)CH₂O)_{y}—(C₂H₄O)_{z}—OH wherein x is from about 50 to about 300, y is from about 20 to about 100, and z is from about 10 to about 200, can be a block copolymer or random copolymer.

The water-soluble carrier can comprise: polyethylene glycol; a polyalkylene polymer of formula H—(C₂H₄O)ₓ—(CH(CH₃)CH₂O)_{y}—(C₂H₄O)_{z}—OH wherein x is from about 50 to about 300; y is from about 20 to about 100, and z is from about 10 to about 200; a polyethylene glycol fatty acid ester of formula (C₂H₄O)_{q}—C(O)O—(CH₂)ᵣ—CH₃ wherein q is from about 20 to about 200 and r is from about 10 to about 30; and a polyethylene glycol fatty alcohol ether of formula HO—(C₂H₄O)—(CH₂)ₜ)—CH₃ wherein s is from about 30 to about 250 and t is from about 10 to about 30.

The water-soluble carrier can comprise from about 20% to about 80% by weight of the particles of polyalkylene polymer of formula H—(C₂H₄O)ₓ—(CH(CH₃)CH₂O)_{y}—(C₂H₄O)_{z}—OH wherein x is from about 50 to about 300; y is from about 20 to about 100, and z is from about 10 to about 200.

The water-soluble carrier can comprise from about 1% to about 20% by weight of the particles polyethylene glycol fatty acid ester of formula (C₂H₄O)_{q}—C(O)O—(CH₂)ᵣ—CH₃ wherein q is from about 20 to about 200 and r is from about 10 to about 30.

The water-soluble carrier can comprise from about 1% to about 10% by weight of the particles of polyethylene glycol fatty alcohol ether of formula HO—(C₂H₄O)ₛ—(CH₂)ₜ)—CH₃ wherein s is from about 30 to about 250 and t is from about 10 to about 30.

Preferably, the water-soluble carrier can be selected from the group consisting of polyethylene glycol, sodium acetate, sodium bicarbonate, sodium chloride, sodium silicate, polypropylene glycol polyoxoalkylene, polyethylene glycol fatty acid ester, polyethylene glycol ether, sodium sulfate, starch, and mixtures thereof. More preferably, the water-soluble carrier can be polyethylene glycol (PEG). PEG can be a convenient material to employ to make particles because it can be sufficiently watersoluble to dissolve during a wash cycle when the particles have the range of mass disclosed herein. Further, PEG can be easily processed as melt. The onset of melt temperature of PEG can vary as a function of molecular weight of the PEG. PEG has a relatively low cost, may be formed into many different shapes and sizes, minimizes unencapsulated perfume diffusion, and dissolves well in water. PEG comes in various weight average molecular weights. In a particularly preferred embodiment of the present invention, the water-soluble carrier is polyethylene glycol (PEG) characterized by a weight average molecular weight (Mw) from about 1,000 to about 40,000 Daltons, preferably from 2,000 to 20,000 Daltons, from about 2,500 to about 15,000 Daltons, more preferably from about 3,000 to about 13,000 Daltons. A particularly suitable PEG is commercially available from BASF under the tradename PLURIOL E 8000 (which has a weight average molecular weight of 9000 even though 8000 is in the product name), while other PLURIOL products are also suitable.

In a further preferred embodiment of the present invention, each of said plurality of anti-microbial particles presented in the composition of the present invention comprises from 30% to 95%, more preferably from 40% to 94%, most preferably from 50% to 93%, of said polyethylene glycol by total weight of said particle.

### Perfumes

Preferably, but not necessarily, each of said plurality of anti-microbial particles further comprises one or more perfume ingredients in the amount ranging from about 0.1% to about 30%, preferably from about 0.5% to about 20%, more preferably from about 1% to about 15% by total weight of said each anti-microbial particle. It has been discovered that incorporation of perfume ingredients into the anti-microbial particles of the present invention surprisingly and unexpected improves the freshness benefit and better malodor control benefit, in comparison with perfume ingredients not incorporated into any particles or with perfume ingredients incorporated into particles that contain the water-soluble carrier but are essentially free of the anti-microbial agent. Without being bound by any theory, it is believed that the presence of the anti-microbial agent may interact with the perfume ingredients to improve the release profile and deposition of such perfume ingredients (especially perfume microcapsules) onto fabrics.

Said one or more perfumes are preferably selected from the group consisting of free perfumes, pro-perfumes, encapsulated perfumes (i.e., perfumes carried by a carrier material such as starch, cyclodextrin, silica, zeolites or clay), perfume microcapsules, and combinations thereof. Preferably, the anti-microbial particles of the present invention contain perfume microcapsules (PMCs), especially friable PMCs. For purpose of the present invention, the term “perfume microcapsules” or PMCs cover both perfume microcapsules and perfume nanoparticles. In one embodiment, the PMCs comprise melamine/formaldehyde shells, which are commercially available from Appleton, Quest International, International Flavor & Fragrances, or other suitable sources. In a preferred embodiment, the shells of the PMCs are coated with polymer to enhance the ability of the PMCs to adhere to fabric. The anti-microbial particles of the present invention may comprise from about 0.1% to about 20%, preferably from about 1% to about 15%, more preferably from about 5% to about 10% of perfume microcapsules by total weight of each of said anti-microbial particles. In a particularly preferred embodiment, each of said anti-microbial particles comprises a combination of free perfumes and perfume microcapsules. More preferably, the weight ratio of free perfumes to perfume microcapsules in said each anti-microbial particle ranges from about 1:5 to about 20:1, preferably from about 1:2 to about 10:1, more preferably from about 1:1 to about 5:1, most preferably from about 1.5:1 to about 3:1.

### Other Actives

Preferably, but not necessarily, each of said plurality of anti-microbial particles further comprises a quaternary ammonium compound to provide additional fabric softening benefit. Specifically, the quaternary ammonium compound, when released from the anti-microbial particles of the present invention during wash, is deposited from the wash liquor onto the fibers of the fabric to provide the consumer with a feeling of softness. For example, each of said plurality of anti-microbial particles may comprise from about 5% to about 45%, preferably from about 10% to about 40%, more preferably from about 15% to about 35% of a quaternary ammonium compound formed from a parent fatty acid compound having an lodine Value from about 18 to about 60, preferably from about 20 to about 60, by total weight of said each anti-microbial particle. Preferably, the quaternary ammonium compound is an ester quaternary ammonium compound, and more preferably di-(tallowoyloxyethl)-N,N-methylhydroyethylammonium methyl sulfate.

In addition to the quaternary ammonium compound described hereinabove, the anti-microbial particles of the present invention may further comprise a cationic polymer, which functions to promote deposition of the quaternary ammonium compound onto the fabrics and to boost the fabric softening performance thereof. Each of said plurality of anti-microbial particles may comprise from about 0.5% to about 10%, preferably from about 1% to about 5% of such cationic polymer by total weight of said each anti-microbial particle. The cationic polymer is preferably a cationic polysaccharide, more preferably polymeric quaternary ammonium salt of hydroxyethylcellulose which has been reacted with an epoxide substituted with a trimethylammonium group. More preferably, the weight ratio of the quaternary ammonium compound to the cationic polymer in said each particle may range from about 3:1 to about 30:1, optionally from about 5:1 to about 15:1, optionally from about 5:1 to about 10:1, optionally about 8:1. Without being bound by theory, the mass fraction of quaternary ammonium compound and mass fraction of cationic polymer are balanced to achieve assistance from the cationic polymer to deposit satisfactory levels of deposition of the quaternary ammonium compound onto the fabric being treated.

In order to provide an aesthetic appearance that is pleasing to the consumer or a visual cue that highlights certain ingredients or benefits, each of said plurality of anti-microbial particles may further comprise from about 0.0001% to about 1%, preferably from about 0.001% to about 0.5%, more preferably from about 0.005% to about 0.1% of one or more colorants by total weight of said each anti-microbial particle. The colorants can be selected from the group consisting of dyes, pigments, and combinations thereof. Preferably, the colorants impart to the anti-microbial particles a color selected from the group consisting of blue, green, yellow, orange, pink, red, purple, grey, and the like.

The anti-microbial particles of the present invention may further comprise a water-soluble or water-dispersible filler, e.g., sodium chloride, sodium sulfate, sodium carbonate, sodium bicarbonate, sugar, starch, modified cellulose, silica, zeolite, clay, and the like. Preferably, each of the particles can comprise from about 0.1% to about 7% of clay by total weight of said each particle. More preferably, the clay is bentonite.

It is particularly preferred that the anti-microbial particles of the present invention are substantially free of or essentially free of surfactants, because the presence of such surfactants may speed up dissolution or dispersion of the anti-microbial agent in water and reduce its deposition onto the fabrics, which is undesirable in the context of the present invention. More preferably, the anti-microbial particles of the present invention are substantially free of or essentially free of any detersive actives.

The anti-microbial particles of the present invention preferably contain less than about 10%, optionally less than about 8%, optionally less than about 5%, optionally less than about 3% of water by total weight of each of said anti-microbial particles. Decreasing or having these ranges of water content are thought to provide particles that are more stable. The lower the mass fraction of water, the more stable the particles are thought to be.

Each of the anti-microbial particles of the present invention has a mass from about 5 mg to about 500 mg, preferably from about 10 mg to about 300 mg, further preferably from about 15 mg to about 200 mg, more preferably from about 20 mg to about 150 mg, most preferably from about 20 mg to about 100 mg.

Said particles may be formed into tablets, pills, spheres, and the like. They can have any shape selected from the group consisting of spherical, hemispherical, compressed hemispherical, cylindrical, disc, circular, lentil-shaped, oblong, cubical, rectangular, star-shaped, flower-shaped, and any combinations thereof. Lentil-shaped refers to the shape of a lentil bean. Compressed hemispherical refers to a shape corresponding to a hemisphere that is at least partially flattened such that the curvature of the curved surface is less, on average, than the curvature of a hemisphere having the same radius. A compressed hemispherical particle can have an aspect ratio (i.e., the ratio of its base diameter over its height that is orthogonal to the base) of from about 1.5 to about 5, alternatively from about 2.1 to about 4.5, alternatively from about 2.2 to about 4. Oblong-shaped particle refers to a particle having a maximum dimension and a secondary dimension orthogonal to the maximum dimension, wherein the ratio of maximum dimension to the secondary dimension is greater than about 1.2, preferably greater than about 1.5, more preferably greater than about 2. Preferably, the anti-microbial particles of the present invention have a hemispherical or compressed hemispherical shape.

Preferably, said anti-microbial particles are characterized by a longest dimension of from about 3 mm to about 10 mm, preferably from about 4 mm to about 9 mm, more preferably from about 5 mm to about 8 mm; and/or an aspect ratio from about 1 to about 5, preferably from about 1.5 to about 4, more preferably from about 2 to about 4.

In a preferred but not necessary embodiment of the present invention, the anti-microbial particles of the present invention have a density lower than water, so that they can float on water and are more noticeable by the consumers during wash. For example, such anti-microbial particles may have a density ranging from about 0.5 g/cm³ to about 0.98 g/cm³, preferably from about 0.7 g/cm³ to about 0.95 g/cm³, more preferably from about 0.8 g/cm³ to about 0.9 g/cm³.

The plurality of anti-microbial particles of the present invention can have different shapes, sizes, mass, and/or density.

### Use of the Anti-Microbial Particles in Stand-Alone Particulate Products

Particulate products, especially particulates that are not dusty, are preferred by many consumers. Particulate products can be easily dosed by consumers from a package directly into the washing machine or into a dosing compartment on the washing machine. Or the consumer can dose from the package into a dosing cup that optionally provides one or more dosing indicia and then dose the particulates into a dosing compartment on the washing machine or directly to the drum. For products in which a dosing cup is employed, particulate products tend to be less messy than liquid products.

The plurality of anti-microbial particles as mentioned hereinabove can be provided as a stand-alone particulate product for through-the-wash fabric treatment, which is convenient for the consumer to dose to the washing machine. The stand-alone particulate product may consist essentially of the anti-microbial particles of the present invention, or it may contain other particles similar to the anti-microbial particles, e.g., perfume particles, softening particles, bleach particles, etc., which contain little or no surfactant or which is of similar sizes as the anti-microbial particles. The stand-alone particulate product may be provided in a package that is separate from the package of detergent composition. Having the anti-microbial particles in a package separate from the package of detergent composition can be beneficial since it allows the consumer to select the amount of anti-microbial agent to be dosed, independent of the amount of detergent composition used. This can give the consumers the opportunity to customize the amount of anti-microbial agent used and thereby the resulting anti-microbial benefit based on their needs, which is a highly valuable consumer benefit.

### Particulate Laundry Detergent Products Comprising the Anti-Microbial Particles

In a preferred but not necessary embodiment of the present invention, the anti-microbial particles of the present invention are present in a particulate laundry detergent composition which also contain detergent particles. Preferably, the plurality of anti-microbial particles are present in said particulate laundry detergent composition as a minor portion, e.g., in an amount ranging from about 0.05% to about 30%, preferably from about 0.1% to about 20%, more preferably from about 0.5% to about 15%, most preferably from about 1% to about 10% by total weight of said particulate laundry detergent composition.

The particulate laundry detergent composition may comprise the detergent particles in an amount ranging from about 10% to about 99.9%, preferably from about 20% to about 95%, more preferably from about 30% to about 90%, most preferably from about 40% to about 80% by total weight of said particulate laundry detergent composition. The detergent particles of the present invention may comprise one or more detersive actives, such as surfactants, builders, bleach actives, enzymes, polymers, chelants, softeners, suds suppressors, suds boosters, brighteners, dye transfer inhibitors, and the like. The detergent particles can be spray-dried particles and/or agglomerated particles and/or extruded particles. Such detergent particles may be selected from: surfactant particles, including surfactant agglomerates, surfactant extrudates, surfactant needles, surfactant noodles, surfactant flakes; polymer particles such as cellulosic polymer particles, polyester particles, polyamine particles, terephthalate polymer particles, polyethylene glycol polymer particles; builder particles, such as sodium carbonate and sodium silicate co-builder particles, phosphate particles, zeolite particles, silicate salt particles, carbonate salt particles; filler particles such as sulphate salt particles; dye transfer inhibitor particles; dye fixative particles; bleach particles, such as percarbonate particles, especially coated percarbonate particles, such as percarbonate coated with carbonate salt, sulphate salt, silicate salt, borosilicate salt, or any combination thereof, perborate particles, bleach catalyst particles such as transition metal bleach catalyst particles, or oxaziridinium-based bleach catalyst particles, pre-formed peracid particles, especially coated pre-formed peracid particles, and co-bleach particles of bleach activator, source of hydrogen peroxide and optionally bleach catalyst; bleach activator particles such as oxybenzene sulphonate bleach activator particles and tetra acetyl ethylene diamine bleach activator particles; chelant particles such as chelant agglomerates; hueing dye particles; brightener particles; enzyme particles such as protease prills, lipase prills, cellulase prills, amylase prills, mannanase prills, pectate lyase prills, xyloglucanase prills, bleaching enzyme prills, cutinase prills and co-prills of any of these enzymes; clay particles such as montmorillonite particles or particles of clay and silicone; flocculant particles such as polyethylene oxide particles; wax particles such as wax agglomerates.

Preferably, such detergent particles are surfactant particles containing from about 10% to about 90%, preferably from about 15% to about 80%, more preferably from about 20% to about 70%, of a surfactant by total weight of said detergent particles. More preferably, the surfactant is selected from 5 the group consisting of anionic surfactants, nonionic surfactants, cationic surfactants, amphoteric surfactants, zwitterionic surfactants, and combinations thereof. Most preferably, the detergent particles of the present invention comprise an anionic surfactant and/or a nonionic surfactant.

The detergent particles of the present invention may be characterized by a Median Weight Particle Size (Dw50) of from about 250 μm to about 1000 μm, preferably from about 300 μm to about 950 μm, more preferably from about 400 μm to about 850 μm. Preferably, such detergent particles have a white or light-colored appearance, while the anti-microbial particles have a blue, green, yellow, orange, pink, red, purple or grey color so that they are visually contrasting with the detergent particles.

In addition to the anti-microbial particles and detergent particles described hereinabove, the particulate laundry detergent composition of the present invention may comprise one or more detergent ingredients. Suitable detergent ingredients include: detersive surfactants including anionic detersive surfactants, non-ionic detersive surfactants, cationic detersive surfactants, zwitterionic detersive surfactants, amphoteric detersive surfactants, and any combination thereof; polymers including carboxylate polymers, polyethylene glycol polymers, polyester soil release polymers such as terephthalate polymers, amine polymers, cellulosic polymers, dye transfer inhibition polymers, dye lock polymers such as a condensation oligomer produced by condensation of imidazole and epichlorhydrin, optionally in ratio of 1:4:1, hexamethylenediamine derivative polymers, and any combination thereof; builders including zeolites, phosphates, citrate, and any combination thereof; buffers and alkalinity sources including carbonate salts and/or silicate salts; fillers including sulphate salts and bio-filler materials; bleach including bleach activators, sources of available oxygen, pre-formed peracids, bleach catalysts, reducing bleach, and any combination thereof; chelants; photobleach; hueing agents; brighteners; enzymes including proteases, amylases, cellulases, lipases, xylogucanases, pectate lyases, mannanases, bleaching enzymes, cutinases, and any combination thereof; fabric softeners including clay, silicones, quaternary ammonium fabric-softening agents, and any combination thereof; flocculants such as polyethylene oxide; perfume including starch encapsulated perfume accords, perfume microcapsules, perfume loaded zeolites, schif base reaction products of ketone perfume raw materials and polyamines, blooming perfumes, and any combination thereof; aesthetics including soap rings, lamellar aesthetic particles, geltin beads, carbonate and/or sulphate salt speckles, colored clay, and any combination thereof; and any combination thereof.

In a preferred embodiment of the present invention, the particulate laundry detergent composition comprises one or more builders (not including the carbonate as described hereinabove) in the amount ranging from about 1 wt % to about 40 wt %, typically from 2 wt % to 25 wt %, or even from about 5 wt % to about 20 wt %, or from 8 wt to 15 wt % by total weight of such composition. Builders as used herein refers to any ingredients or components that are capable of enhancing or improving the cleaning efficiency of surfactants, e.g., by removing or reducing “free” calcium/magnesium ions in the wash solution to “soften” or reducing hardness of the washing liquor.

It is particularly desirable that such particulate laundry detergent composition has relatively low levels of phosphate builder, zeolite builder, and silicate builder. Preferably, it contains at most 15 wt % by weight of phosphate builder, zeolite builder, and silicate builder in total. More preferably, such particulate laundry detergent composition contains from 0 wt % to about 5 wt % of phosphate builder, from 0 wt % to about 5 wt % of zeolite builder, and from 0 wt % to about 10 wt % of silicate builder, while the total amounts of these builders add up to no more than 10 wt % by total weight of the composition. Still more preferably, the particulate laundry detergent composition contains from 0 wt % to about 2 wt % of phosphate builder, from 0 wt % to about 2 wt % of zeolite builder, and from 0 wt % to about 2 wt % of silicate builder, while the total amounts of these builders add up to no more than 5 wt % by total weight of the composition. Most preferably, the particulate laundry detergent composition contains from 0 wt % to about 1 wt % of phosphate builder, from 0 wt % to about 1 wt % of zeolite builder, and from 0 wt % to about 1 wt % of silicate builder, while the total amounts of these builders add up to no more than 2 wt % by total weight of the composition. The composition may further comprise any other supplemental builder(s), chelant(s), or, in general, any material which will remove calcium ions from solution by, for example, sequestration, complexation, precipitation or ion exchange. In particular, the composition may comprise materials having at a temperature of 25° C. and at a 0.1M ionic strength a calcium binding capacity of at least 50 mg/g and a calcium binding constant log K Ca²⁺ of at least 3.50.

The particulate laundry detergent composition of the present invention may contain one or more solid carriers selected from the group consisting of sodium chloride, potassium chloride, sodium sulphate, and potassium sulphate. In a preferred, but not necessary embodiment, such particulate laundry detergent composition includes from about 20 wt % to about 65 wt % of sodium chloride and/or from about 20 wt % to about 65 wt % of sodium sulphate. When the particulate laundry detergent composition is in a concentrated form, the total amount of sodium chloride and/or sodium sulphate in such composition may sum up, for example, to a total amount of from about 0 wt % to about 60 wt %.

### Methods of Using the Anti-Microbial Particles

The anti-microbial particles of the present invention are particularly useful for treating fabrics in a machine-washing or hand-washing setting to provide an anti-microbial benefit and optionally an improved fabric freshness and malodor control benefit. They enable consumers to achieve anti-microbial benefit through the wash, in particular the wash sub-cycle. By providing anti-microbial benefit through the wash sub-cycle, consumers only need to dose the detergent composition and the anti-microbial particles to a single location, for example the wash basin, prior to or shortly after the start of the washing machine.

The process for treating an article of clothing can comprise the steps of providing an article of clothing in a washing machine. The article of clothing is contacted during the wash sub-cycle of the washing machine with a composition comprising a plurality of the anti-microbial particles disclosed herein. The particles can dissolve into water provided as part of the wash sub-cycle to form a liquor. The dissolution of the particles can occur during the wash sub-cycle.

Washing machines have at least two basic sub-cycles within a cycle of operation: a wash sub-cycle and a rinse sub-cycle. The wash sub-cycle of a washing machine is the cycle on the washing machine that commences upon first filling or partially filing the wash basin with water. A main purpose of the wash sub-cycle is to remove and or loosen soil from the article of clothing and suspend that soil in the wash liquor. Typically, the wash liquor is drained at the end of the wash sub-cycle. The rinse sub-cycle of a washing machine occurs after the wash sub-cycle and has a main purpose of rinsing soil, and optionally some benefit agents provided to the wash sub-cycle from the article of clothing.

The process can optionally comprise a step of contacting the article of clothing during the wash sub-cycle with a detergent composition comprising an anionic surfactant. Most consumers provide a detergent composition to the wash basin during the wash sub-cycle. Detergent compositions can comprise anionic surfactant, and optionally other benefit agents including but not limited to perfume, bleach, brighteners, hueing dye, enzyme, and the like. During the wash sub-cycle, the benefit agents provided with the detergent composition are contacted with or applied to the article of clothing disposed in the wash basin. Typically, the benefit agents of detergent compositions are dispersed in a wash liquor of water and the benefit agents.

During the wash sub-cycle, the wash basin may be filled or at least partially filled with water. The anti-microbial particles can dissolve into the water to form a wash liquor comprising the components of the particles. Optionally, if a detergent composition is employed or if the anti-microbial particles are formulated into a particulate laundry detergent composition, the wash liquor can include the components of the detergent composition and the components of the dissolved particles. The particles can be placed in the wash basin of the washing machine before the article of clothing is placed in the wash basin of the washing machine. The particles can be placed in the wash basin of the washing machine after the article of clothing is placed in the wash basin of the washing machine. The particles can be placed in the wash basin prior to filling or partially filling the wash basin with water or after filling of the wash basin with water has commenced.

If a detergent composition is employed by the consumer in practicing the process of treating an article of clothing, the detergent composition and anti-microbial particles can be provided from separate packages. For instance, the detergent composition can be a liquid detergent composition provided from a bottle, sachet, water-soluble pouch, dosing cup, dosing ball, or cartridge associated with the washing machine. The anti-microbial particles can be provided from a separate package, by way of non-limiting example, a carton, bottle, water-soluble pouch, dosing cup, sachet, or the like. If the detergent composition is a solid form, such as a powder, water-soluble fibrous substrate, water-soluble sheet, water-soluble film, water-soluble film, water insoluble fibrous web carrying solid detergent composition, the particles can be provided with the solid form detergent composition. For instance, the particles can be provided from a container containing a mixture of the solid detergent composition and the particles. Optionally, the particles can be provided from a pouch formed of a detergent composition that is a water-soluble fibrous substrate, water-soluble sheet, water-soluble film, water-soluble film, water insoluble fibrous web carrying solid detergent composition.

The laundry liquor used for dissolving the anti-microbial particles and treating fabrics may have a pH value that is chosen to be the most complimentary to the fabrics to be cleaned spanning broad range of pH, e.g., from about 5 to about 11, preferably from about 8 to about 10. The water temperatures preferably range from about 5° C. to about 100° C. The water to fabric ratio is typically from about 1:1 to about 30:1. The wash liquor may comprise 40 litres or less of water, or 30 litres or less, or 20 litres or less, or 10 litres or less, or 8 litres or less, or even 6 litres or less of water. The wash liquor may comprise from above 0 to 15 litres, or from 2 litres, and to 12 litres, or even to 8 litres of water. For dilute wash conditions, the wash liquor may comprise 150 litres or less of water, 100 litres or less of water, 60 litres or less of water, or 50 litres or less of water, especially for hand-washing conditions, and can depend on the number of rinses.

Typically, from 0.01 Kg to 2 Kg of fabric per litre of wash liquor is dosed into the wash liquor. Typically, from 0.01 Kg, or from 0.05 Kg, or from 0.07 Kg, or from 0.10 Kg, or from 0.15 Kg, or from 0.20 Kg, or from 0.25 Kg, to 1.8 Kg, or to 1.6 Kg, or to 1.5 Kg, or to 1.3 Kg, or to 1.1 Kg, or to 0.9 Kg, or to 0.7 Kg, or to 0.5 Kg, of fabric per litre of wash liquor is dosed into the wash liquor.

### Production of Anti-Microbial Particles

For a carrier that can be processed conveniently as a melt, the rotoforming process can be used. A mixture of molten carrier and the other materials constituting the particles is prepared, for instance in a batch or continuous mixing process. The molten mixture can be pumped to a rotoformer, for instance a Sandvik ROTOFORM 3000 having a 750 mm wide 10 m long belt. The rotoforming apparatus can have a rotating cylinder. The cylinder can have 2 mm diameter apertures set at a 10 mm pitch in the cross machine direction and 9.35 mm pitch in the machine direction. The cylinder can be set at approximately 3 mm above the belt. The belt speed and rotational speed of the cylinder can be set at about 10 m/min. The molten mixture can be passed through the apertures in the rotating cylinder and deposited on a moving conveyor that is provided beneath the rotating cylinder.

The molten mixture can be cooled on the moving conveyor to form a plurality of solid particles. The cooling can be provided by ambient cooling. Optionally the cooling can be provided by spraying the under-side of the conveyor with ambient temperature water or chilled water.

Once the particles are sufficiently coherent, the particles can be transferred from the conveyor to processing equipment downstream of the conveyor for further processing and or packaging.

Optionally, the particles can be provided with inclusions of a gas. Such occlusions of gas, for example air, can help the particles dissolve more quickly in the wash. Occlusions of gas can be provided, by way of nonlimiting example, by injecting gas into the molten precursor material and milling the mixture.

Particles can also be made using other approaches. For instance, granulation or press agglomeration can be appropriate. In granulation, the precursor material containing the constituent materials of the particles is compacted and homogenized by rotating mixing tools and granulated to form particles. For precursor materials that are substantially free of water, a wide variety of sizes of particles can be made.

In press agglomeration, the precursor material containing the constituent materials of the particles is compacted and plasticized under pressure and under the effect of shear forces, homogenized and then discharged from the press agglomeration machine via a forming/shaping process. Press agglomeration techniques include extrusion, roller compacting, pelleting, and tableting.

The precursor material containing the constituent materials of the particles can be delivered to a planetary roll extruder or twin screw extruder having co-rotating or contra-rotating screws. The barrel and the extrusion granulation head can be heated to the desired extrusion temperature. The precursor material containing the constituent materials of the particles can be compacted under pressure, plasticized, extruded in the form of strands through a multiple-bore extrusion die in the extruder head, and sized using a cutting blade. The bore diameter of the of extrusion header can be selected to provide for appropriately sized particles. The extruded particles can be shaped using a spheronizer to provide for particles that have a spherical shape.

Optionally, the extrusion and compression steps may be carried out in a low-pressure extruder, such as a flat die pelleting press, for example as available from Amandus Kahl, Reinbek, Germany. Optionally, the extrusion and compression steps may be carried out in a low pressure extruder, such as a BEXTRUDER, available from Hosokawa Alpine Aktiengesellschaft, Augsburg, Germany.

The particles can be made using roller compacting. In roller compacting the precursor material containing the constituent materials of the particles is introduced between two rollers and rolled under pressure between the two rollers to form a sheet of compactate. The rollers provide a high linear pressure on the precursor material. The rollers can be heated or cooled as desired, depending on the processing characteristics of the precursor material. The sheet of compactate is broken up into small pieces by cutting. The small pieces can be further shaped, for example by using a spheronizer.

### Test Methods

The following techniques must be used to determine the properties of the perfume particles, the detergent particles, and the particulate laundry detergent compositions of the invention in order that the invention described and claimed herein may be fully understood.

### Test 1: Anti-Microbial Test

The Anti-microbial test can be done following the instructions described in section 2.1.1.7.4 of “Technical Standard For disinfection (2002)”, issued by China's Ministry of Health.

### Test 2: Dissolution Rate Test

The Dissolution Rate Test is used to measure the speed of dissolution of the particles.

This test is conducted by adding 400 ml of de-ionized water into a 400 ml transparent glass beaker at room temperature (25° C.), then dispersing about 1 gram of test particles into the deionized water. Use stop watch to count the total time needed before the particles are fully dissolved.

### Test 3: Particle Aspect Ratio

For non-spherical particles, the particle's longest dimension and shortest dimension can be measured by using Vernier calipers. To reduce the variation of the data, typically 10 particles can be measured and then use the average result. The particle aspect ratio herein is calculated by using this formula: Aspect ratio=Longest dimension/Shortest dimension.

### Test 4: AVO Test

AVO test is a test method detecting available oxygen in granular composition by titration, showing the bleaching active of the anti-microbial agent. The higher the AVO % is, the more bleaching active of the agent shows. Materials and test procedures are summarized below.

### Material Preparation:

1. Potassium Iodide: Tianjin Guangfu Technical Developing Ltd. lot #M028155-001CISPro #C3682345
2. Glacial acetic acid: Tianjin Chemical Agent No.1 Factory lot #M154289-002 CISPro #C4258166
3. Starch soluble: Tianjin Yingdaxigui Chemical Agent Factory M028053-001 CISPro #3942832
4. 1 N Sodium thiosulphate: Merck Lot #MO27159-003CISPro #3941904
5. 40% KI solution: Weighing 40 g KI into 100 ml flask. Adding DI-water to volume, stir to dissolve.
6. Starch indicator: Weighing 1 g starch to beaker, adding DI-water to 100 g. Heating to boiling.

### Procedure:

1. Weighing about 10 g sample into grinding apparatus and grinding about 30-60 s.
2. Weighing 2 g grinding sample into a 250 ml conical flask. Recording weight as Wg, accurately 0.001 g.
3. Diluting with 50 ml glacial acetic acid. Stirring to dissolve.
4. Adding 10 mL of 40% potassium iodide solution.
5. Adding about 1 mL starch indicator solution
6. Continuing the titration slowly until the solution becomes colorless and remains without color for at least 10 seconds.
7. Recording the volume to reach the end point as T mL.

### Calculation:

$$\% AvO = \frac{T * N * 0.8}{Wg}$$

### EXAMPLES

The Examples herein are meant to exemplify the present invention but are not used to limit or otherwise define the scope of the present invention.

### Example 1: Preparation of Anti-Microbial Particles Containing Percarbonate

An inventive sample (Example A) containing anti-microbial particles of the present invention is provided. A comparative sample (Example B) containing particles (free of anti-microbial agent) and separate anti-microbial agent (not incorporated into the particles) is also provide. Table 1 shows the constitutes of the samples.

The anti-microbial particle containing percarbonate and TAED (i.e. Example A) is prepared according to the below procedure.
1. Pre-melting the PEG9000 (BASF) in 75° C. oven.
2. Pre-heating the mold and scraper in 75° C. oven.
3. Weighing the PEG9000 to target mass in a 100 mL plastic beaker.
4. Placing the beaker in 75° C. water bath.
5. Mixing speed with agitation blade is set to 500RMP.
6. Weighing the Sodium percarbonate (SPCS, Zhejiang Jinke Household Chemical Materials Co., Ltd) and TAED (TAED, Zhejiang Jinke Household Chemical Materials Co., Ltd) in the same beaker and mix for 5 min.
7. Pouring blended mixture on mold and flattening the surface.
8. leaving the mold in room temperature so that the beads cool down and solidify.
9. Collecting the beads from the mold.

Example B contains, separately, PEG9000 particles and ground sodium percarbonate and ground TAED with at the same amount as in Example A. The PEG9000 particle is prepared according to above procedure except without step 6.

TABLE 1

| Ingredients | Example A (wt %) | Example B (wt %) |
|---|---|---|
| PEG 9000 | 92.3% (in particle) | 92.3% (particle) |
| Sodium Percarbonate | 4.5% (in particle) | 4.5% (separate granule) |
| TAED | 3.2% (in particle) | 3.2% (separate granule) |
| | aging | aging |

Example A and B are then both aged for 24 hrs under 32° C./80RH condition. And the AVO test for the aged Examples are then undertaken according to the method described above in Test 4, and the AVO % are listed in below Table 2.

TABLE 2

| | Example A | Example B |
|---|---|---|
| Avo % | 42.7% | 28.1% |

The above results show a significantly higher AVO % for the anti-microbial agents when it is incorporated into the particles vs. when it is added separately, after aged 24 hours at 32° C./80RH condition that simulate the shipping/shelf life situation.

### Example 2: Preparation of Anti-Microbial Particles Containing PCMX

Anti-microbial particles containing PCMX are prepared according to similar method described in Example 1, except that certain amount of PCMX are added into melt PEG8000 by agitation. Examples C to F are samples containing different amount of PCMX, listed in Table 3 below. Examples C to E are Inventive Examples, while Example F is a Comparative Example which is out of the scope of the present invention. In fact, there is difficulty during processing to solidity in room temperature.

| | Particle Components (wt %) | | Can form a solid |
|---|---|---|---|
| Examples | PCMX | PEG8000 | particle |
| Inventive Example C | 4.12% | 95.88% | Yes |
| Inventive Example D | 8.25% | 91.75% | Yes |
| Inventive Example E | 16.50% | 83.50% | Yes |
| Comparative | 33% | 67% | No |
| Example F | | | |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A laundry additive composition comprising a plurality of anti-microbial particles that each comprises:
a) from 20% to 99.9% of water soluble carrier by total weight of said particle; and
b) from 0.001% to 30% of an anti-microbial agent by total weight of said particle, wherein said anti-microbial agent is selected from the group of chloroxylenol, percarbonate, silver, methyl-diisopropanolamine-based quaternary ammonium compound, didecyldimethyl ammonium chlorides, benzalkonium chlorides, and any combinations thereof;
wherein each of said particles has a mass between 5 mg and 500 mg.

2. The laundry additive composition according to claim 1, wherein
i) each of said plurality of anti-microbial particles comprises from 0.1% to 30%, of chloroxylenol by total weight of said particle; and/or
ii) each of said plurality of anti-microbial particles comprises from 0.1% to 30%, of percarbonate by total weight of said particle; and/or
iii) each of said plurality of anti-microbial particles comprises 0.001% to 5%, of silver by total weight of said particle; and/or
iv) each of said plurality of anti-microbial particles comprises from 0.1% to 30%, of methyl-diisopropanolamine-based (MDIPA-based) quaternary ammonium compound by total weight of said particle; and/or
v) each of said plurality of anti-microbial particles comprises from 0.1% to 30%, of didecyldimethyl ammonium chlorides (DDAC) by total weight of said particle; and/or
vi) each of said plurality of anti-microbial particles comprises from 0.1% to 30%, of benzalkonium chlorides by total weight of said particle; and/or
vii) each of said plurality of anti-microbial particles comprises from 0.1% to 30%, of cationic polymers by total weight of said particle, wherein said cationic polymer is a cationic polysaccharide.

3. The laundry additive composition according to claim 1, wherein the water soluble carrier is selected from the group of polyethylene glycol, sodium acetate, sodium bicarbonate, sodium chloride, sodium silicate, polypropylene glycol polyoxoalkylene, polyethylene glycol fatty acid ester, polyethylene glycol ether, sodium sulfate, starch, and any combinations thereof, the water soluble carrier is polyethylene glycol having a weight average molecular weight from 2,000 to 20,000 Daltons, wherein the polyethylene glycol is present in an amount of from 30% to 95%, by total weight of said particle.

4. The laundry additive composition according to claim 1, wherein each of said plurality of anti-microbial particles further comprises from 0.1% to 30% of a perfume by total weight of said particle; wherein said perfume is selected from the group of free perfumes, pro-perfumes, encapsulated perfumes, perfume microcapsules, and combinations thereof.

5. The laundry additive composition according to claim 1, wherein each of said plurality of anti-microbial particles further comprises from 0.0001% to 1%, of a colorant by total weight of said particle; wherein said colorant is selected from the group of dyes, pigments, and combinations thereof.

6. The laundry additive composition according to claim 1, wherein each of said plurality of anti-microbial particles is characterized by:
i) a shape selected from the group of spherical, hemispherical, compressed hemispherical, cylindrical, disc, circular, lentil-shaped, oblong, cubical, rectangular, star-shaped, flower-shaped, and combinations thereof; and/or
ii) a longest dimension of from 3 mm to 10 mm; and/or
iii) an aspect ratio from 1 to 5; and/or
iv) a density ranging from 0.5 g/cm³ to 0.98 g/cm³; and/or
v) a mass from 5 mg to 450 mg.

7. The laundry additive composition according to claim 1, wherein the anti-microbial agent comprised in said each of plurality of anti-microbial particles is percarbonate, wherein each of the anti-microbial particle further comprises from 0.1% to 30% of tetraacetylethylene-diamine by total weight of said particle.

8. The laundry additive composition according to claim 1, wherein each of plurality of anti-microbial particles comprises:
a) from 25% to 99% of polyalkylene glycol having a weight average molecular weight from 2000 to 40000 Daltons by total weight of said particle; and
b) from 0.1% to 30% of an anti-microbial agent by total weight of said particle, wherein said anti-microbial agent is percarbonate,
wherein the laundry additive composition further comprises a plurality of additional particles each comprising:
i) from 25% to 99% of polyalkylene glycol having a weight average molecular weight from 2000 to 40000 Daltons by total weight of said additional particle; and
ii) from 0.1% to 30% of tetraacetylethylene-diamine by total weight of said additional particle.

9. A laundry care composition, comprising the laundry additive composition according to claim 1, wherein said laundry additive composition is present in an amount ranging from 0.05% to 30%, by weight in said laundry care composition.

10. The laundry care composition of claim 9, wherein said laundry care composition further comprises from 10% to 99.9% of detergent particles; wherein said detergent particles comprises from 10 wt % to 90 wt % of a surfactant selected from the group of anionic surfactants, nonionic surfactants, cationic surfactants, amphoteric surfactants, zwitterionic surfactants, and combinations thereof.

11. A process for treating an article of clothing comprising the steps of:
a) providing an article of clothing and the composition according to claim 1; and
b) contacting said article of clothing with said composition.

12. A laundry additive composition comprising a plurality of anti-microbial particles, each comprising:
a) from 25% to 99% of polyethylene glycol having a weight average molecular weight from 3,000 to 13,000 Daltons by total weight of said particle;
b) from 0.1% to 15% of sodium percarbonate by total weight of said particle;
c) from 0.1% to 15% of tetraacetylethylene-diamine by total weight of said particle; and
d) from 0.5% to 20% of a perfume by total weight of said particle; wherein the perfume comprises a combination of free perfumes and perfume microcapsules, wherein the weight ratio of the free perfumes to the perfume microcapsules is from 1:2 to 10:1;
wherein the total amount of b) and c) is no more than 25% by total weight of said particle, wherein each of said particle has a mass between 5 mg and 200 mg, wherein each of said particle has a hemispherical or compressed hemispherical shape.
